(19) United States
(12) Patent Application Publication
(10) Pub. No.: US 2023/0303317 A1
(43) Pub. Date: Sep. 28, 2023

(54) STORAGE ASSEMBLY, METHOD AND SYSTEM OF STORING A PERISHABLE ORGANIC LIQUID

(71) Applicant: AgriGate Australia Pty Ltd, Kambah (AU)

(72) Inventor: Peter Ronald Askew, Kambah (AU)

(73) Assignee: AgriGate Australia Pty Ltd, Kambah (AU)

(21) Appl. No.: 17/940,423

(22) Filed: Sep. 8, 2022

(30) Foreign Application Priority Data
Mar. 25, 2022 (AU) 2022202067

(51) Int. Cl. B65D 88/74; B65D 90/00; B65D 88/12

(52) U.S. Cl. CPC B65D 88/748; B65D 88/744; B65D 90/0093; B65D 88/128; B65D 2588/12; B65D 2588/746

(57) ABSTRACT

A storage assembly comprising a tank having a cavity defined by a wall including a sealable port for receiving and storing a perishable organic fluid within the tank, the perishable organic fluid being chilled prior to transfer to the tank; a heat exchange structure at least partially located between an inner and outer wall surface of the wall, wherein prior to receiving the perishable organic fluid the heat exchange structure is configured to chill the cavity; and a sparging structure located within the tank, wherein the sparging structure is in fluid communication with a source of conditioning agent, wherein the sparging structure is configured to: transfer a first portion of the conditioning agent into the tank to purge the tank prior to receiving the perishable organic fluid; and sparge and pressurise the perishable organic fluid with a second portion of the conditioning agent after transfer and sealing within the tank.

The current application claims priority from Australian Provisional Patent Application No. 2022202067, filed 25 Mar. 2022, the contents of which is herein incorporated by reference in its entirety.

### FIELD

The present invention relates to a storage assembly, method and system of storing a perishable organic liquid. In one particular but non-limiting example, the method, storage assembly and system is adapted for storing raw milk.

### BACKGROUND

Assuring the safe transportation and consumption of organic perishable liquids, such as milk and juice, whilst maintaining quality and increasing the shelf life of products is a significant challenge for the food industry. This is particularly the case with many perishable organic liquids which serve as suitable growth medium for micro-organisms which is exacerbated if the organic perishable liquid needs to be in transit for significant time periods.

To address this issue, pasteurization or similar treatments can be applied to the organic perishable liquid prior to and after transportation to reduce, eliminate or control pathogens. However, pasteurized or treated organic perishable liquids is less desired by customers. In particular, application of pasteurization or similar pathogen reduction treatments impose an additional cost and may negatively impact the flavour, nutritional content, and other sensory characteristics, such as colour, of the treated organic perishable liquid. Furthermore, in some instances, certain products can only be made with untreated organic perishable liquid.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

It is an object of the present invention to at least substantially address one or more of the above disadvantages, or at least provide a useful alternative.

In a first aspect there is provided a storage assembly for storing a perishable organic liquid, comprising: a tank having a cavity defined by a wall, wherein the wall includes a sealable port for receiving and storing a perishable organic fluid within the tank, wherein the perishable organic fluid is chilled prior to transfer to the tank; a heat exchange structure at least partially located between an inner and outer wall surface of the wall, wherein prior to receiving the perishable organic fluid the heat exchange structure is configured to chill the cavity; and a sparging structure located within the tank, wherein the sparging structure is in fluid communication with a source of a conditioning agent, wherein the sparging structure is configured to: transfer a first portion of the conditioning agent into the tank to purge the tank prior to receiving the perishable organic fluid; and sparge and pressurise the perishable organic fluid with a second portion of the conditioning agent after transfer and sealing within the tank.

In certain embodiments of the first aspect, the perishable organic fluid is raw milk.

In certain embodiments of the first aspect, the heat exchange structure is a heat exchange conduit structure in fluid communication with a heat exchange fluid source, wherein an insulating material is located between the inner and outer surface of the wall to assist with maintaining a temperature of the perishable organic fluid within the tank after pressurising and sparging.

In certain embodiments of the first aspect, the conditioning agent is carbon dioxide.

In certain embodiments of the first aspect, the sparging structure is in fluid communication with the source of the conditioning agent via a further conduit which is at least partially located between the inner and outer surface of the wall of the tank.

In certain embodiments of the first aspect, the cavity of the tank is chilled to a temperature between 0° C. to 0.5° C. prior to receiving the perishable organic fluid.

In certain embodiments of the first aspect, the sparging structure is configured to sparge the perishable organic fluid with the conditioning agent at a concentration of between 0.06 grams per litre to 1.2 grams per litre.

In certain embodiments of the first aspect, the sparging structure is configured to sparge the perishable organic fluid with the conditioning agent at a concentration of about 0.06 grams per litre.

In certain embodiments of the first aspect, the sparging structure includes a lattice structure of open conduits extending within the cavity of the tank.

In certain embodiments of the first aspect, the sparging structure is configured to pressurise the perishable organic fluid to a pressure of between 1 kPa to 400 kPa above atmospheric pressure.

In certain embodiments of the first aspect, the sparging structure is configured to pressurise the perishable organic fluid to a pressure of about 100 kPa above atmospheric pressure.

In certain embodiments of the first aspect, the tank has a substantially capsule provide which is secured within a rectangular frame support structure to enable stacking of the storage assembly for transportation.

In a second aspect, there is provided method for storing a perishable organic liquid, comprising: chilling a cavity defined by a wall of a tank using a heat exchange structure at least partially located between an inner and outer wall surface of the wall; transferring, from a source of conditioning agent and via a sparging structure located within the tank, conditioning agent into the tank to purge the tank; transferring chilled perishable organic fluid within the tank; sealing the tank; and sparging and pressurising the perishable organic fluid sealed within the tank with the conditioning agent via the sparging structure.

In certain embodiments of the second aspect, the perishable organic fluid is raw milk.

In certain embodiments of the second aspect, exchange liquid through the heat exchange structure in a recirculating manner.

In certain embodiments of the second aspect, the heat exchange structure is a heat exchange conduit structure in fluid communication with a heat exchange fluid source, wherein an insulating material is located between the inner and outer surface of the wall to assist with maintaining a temperature of the perishable organic fluid within the tank after pressurising and sparging.

In certain embodiments of the second aspect, the conditioning agent is carbon dioxide.

In certain embodiments of the second aspect, the method includes chilling the cavity to a temperature between 0° C. to 0.5° C. prior to receiving the perishable organic fluid.

In certain embodiments of the second aspect, the method includes sparging the perishable organic fluid with the conditioning agent at a concentration of between 0.06 grams per litre to 1.2 grams per litre.

In certain embodiments of the second aspect, the method includes sparging the perishable organic fluid with the conditioning agent at a concentration of about 0.06 grams per litre.

In certain embodiments of the second aspect, the method includes pressurising the perishable organic fluid to a pressure of between 1 kPa to 400 kPa above atmospheric pressure.

In certain embodiments of the second aspect, the method includes pressurising the perishable organic fluid to a pressure of about 100 kPa above atmospheric pressure.

In a third aspect, there is provided a system including: a stationary storage assembly comprising a tank having a cavity defined by a wall, wherein the wall includes a sealable port for receiving and storing a perishable organic fluid within the tank; a sparging structure located within the tank, wherein the sparging structure is in fluid communication with a source of a conditioning agent, wherein the sparging structure is configured to: transfer some of the conditioning agent into the tank to purge the tank prior to receiving the perishable organic fluid; and sparge and pressurise the perishable organic fluid with the conditioning agent after transfer and sealing within the tank; and a heat exchange system configured to cool and maintain a storage temperature of the perishable organic fluid within the tank; and a mobile storage assembly configured in accordance with the first aspect or embodiment thereof, wherein the second storage assembly is locatable substantially adjacent to and in fluid communication with the first storage assembly such that the perishable organic fluid stored within the first storage assembly is transferrable to and storage within the tank of the mobile storage assembly.

In certain embodiments of the third aspect, the perishable organic fluid is raw milk and the stationary storage assembly is located at a farm or milking facility.

In certain embodiments of the third aspect, the heat exchange system includes a heat exchange structure at least partially located between an inner and outer wall surface of the wall of the tank of the mobile storage assembly, wherein prior to receiving any perishable organic fluid, the heat exchange structure is configured to chill the cavity, and wherein the insulating material is configured to assist with maintaining a temperature of the perishable organic fluid within the tank after pressurising and sparging.

In a fourth aspect, there is provided a method comprising: a) transferring, from a first source of a conditioning agent and via a sparging structure located within a tank of a stationary storage assembly, conditioning agent into the tank to purge the tank; b) transferring an amount of a perishable organic fluid within a tank of a stationary storage assembly, wherein the amount of perishable organic fluid is less than the maximum capacity of the tank, wherein the tank of the stationary storage assembly has a cavity defined by a wall including a sealable port for receiving and storing the perishable organic fluid within the tank of the stationary storage assembly; c) sparging and pressurising the perishable organic fluid with the conditioning agent after sealing within the tank of the stationary storage assembly; d) repeating steps a) to c) until the tank has reached maximum capacity; and e) locating a mobile storage assembly adjacent the stationary storage assembly; wherein the mobile storage assembly is configured according to the first aspect or embodiments thereof, wherein the perishable organic fluid contained within the tank of the stationary storage assembly is transferred and stored within the tank of the mobile storage assembly using to a method according to the second aspect of embodiments thereof.

In certain embodiments of the fourth aspect, the perishable organic fluid is raw milk and the stationary storage assembly is located at a farm or milking facility.

In certain embodiments of the fourth aspect, the heat exchange system includes a heat exchange structure at least partially located between an inner and outer wall surface of the wall of the tank of the mobile storage assembly, wherein prior to receiving any perishable organic fluid, the method includes chilling the cavity of the tank of the mobile storage assembly using the heat exchange structure.

Other aspects and/or embodiments will be appreciated throughout the detailed description.

### BRIEF DESCRIPTION OF THE DRAWING

Example embodiments should become apparent from the following description, which is given by way of example only, of at least one preferred but non-limiting embodiment, described in connection with the accompanying figures.

FIG. 1 is a side perspective view of an example of a storage assembly for storing a perishable organic liquid.

FIG. 2A is a schematic of a cross-sectional side view of the storage assembly of FIG. 1.

FIG. 2B is a schematic of a cross-section plan view of the storage assembly of FIG. 1.

FIG. 3 is a perspective end view of the storage assembly of FIG. 1.

FIG. 4 is a perspective plan, end view of the storage assembly of FIG. 1.

FIG. 5 is a schematic of a cross-sectional view of portion of a wall of the storage assembly of FIG. 1.

FIG. 6 is a flowchart representing a method of storing a perishable organic liquid.

FIG. 7 is a block diagram of an example system including a stationary and mobile storage system.

FIG. 8 is a flowchart representing an example method performed using the system of FIG. 7.

### DETAILED DESCRIPTION

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

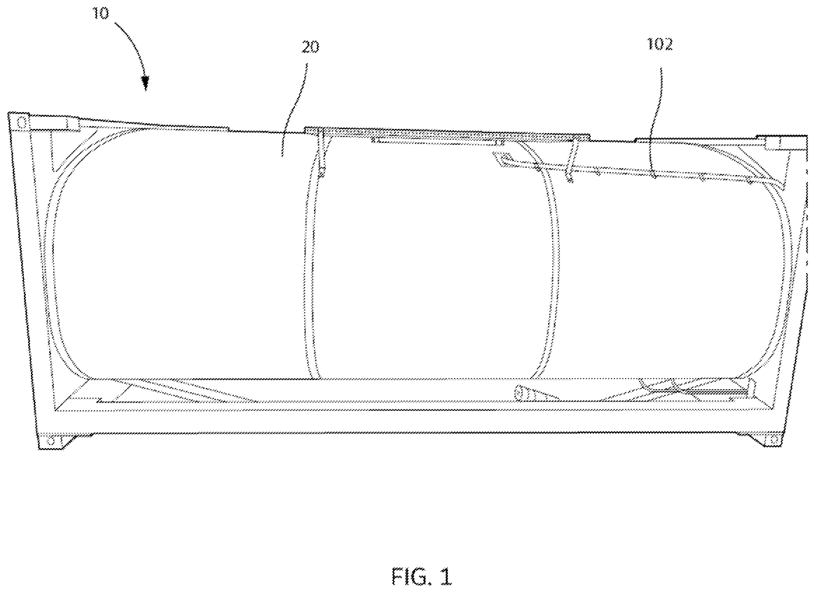

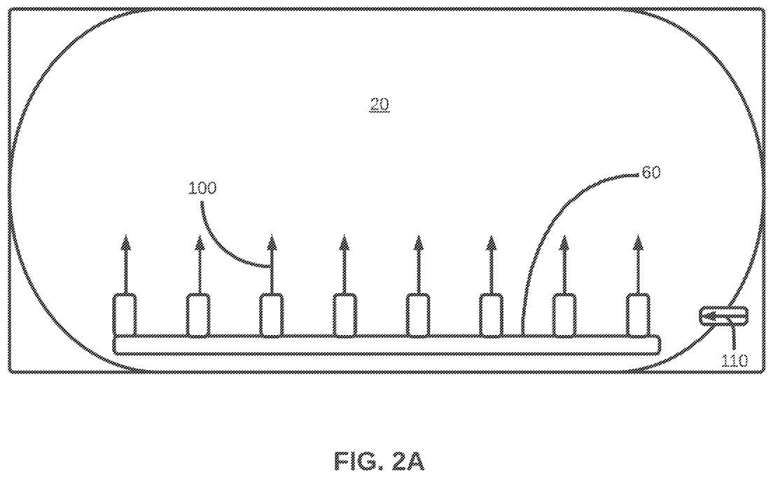

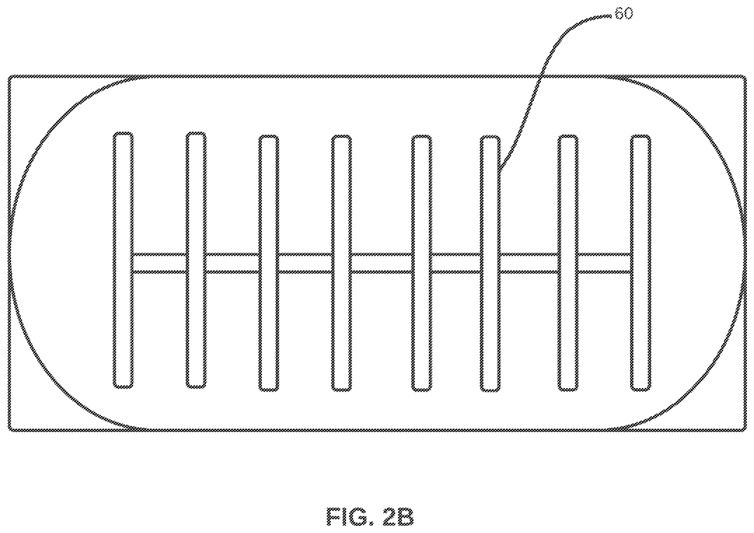

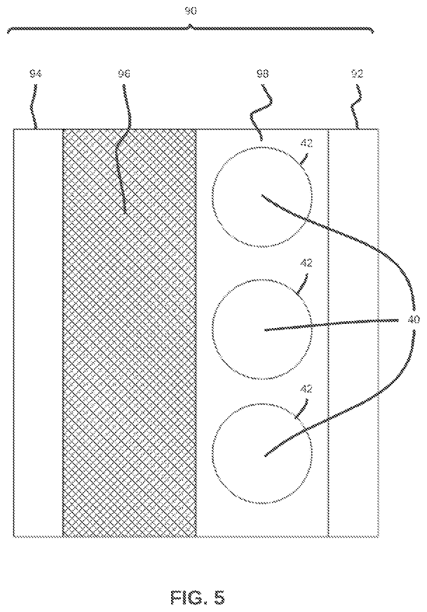

Referring to FIGS. 1 to 5 there is shown an example of a storage assembly 10 for storing a perishable organic liquid. In particular, the storage assembly 10 comprises a tank 20, a heat exchange structure 40 (see FIG. 5), and a sparging structure 60 (see FIGS. 2A and 2B).

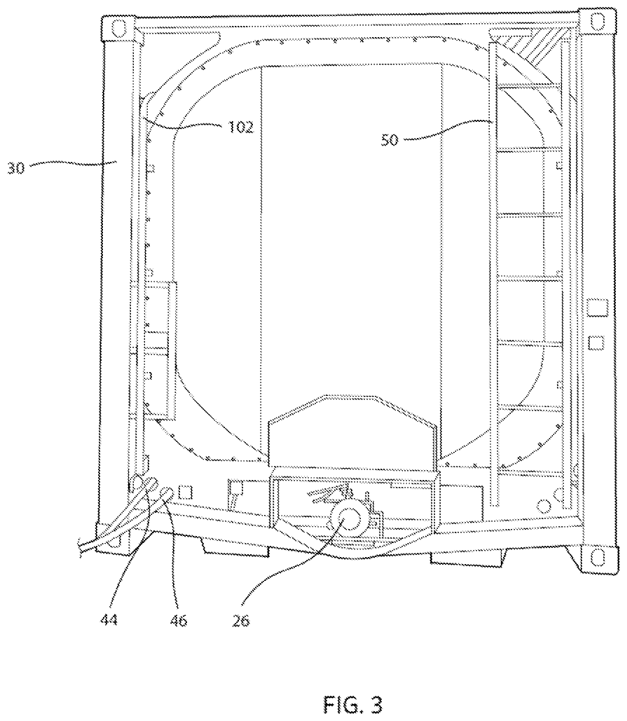

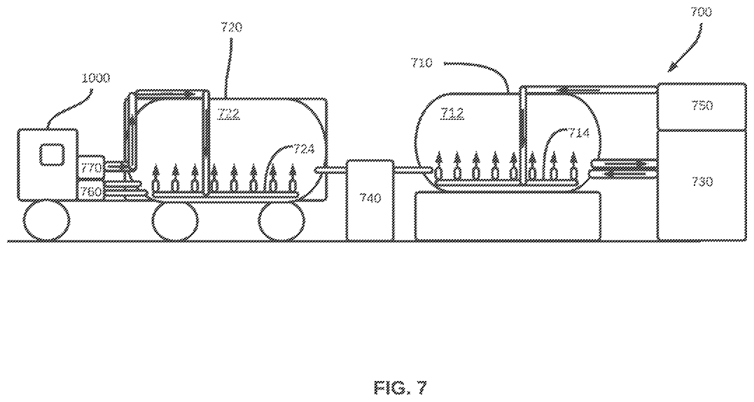

More specifically, referring to FIGS. 3 and 5, the tank 20 has a cavity defined by a wall 90, wherein the wall 90 includes a sealable port 26 (see FIG. 3) for receiving and storing a perishable organic fluid within the tank 20. As shown in FIG. 5, the heat exchange structure 40 is at least partially located between an inner wall surface 92 and outer wall surface 94 of the wall 90 of the tank 20. As shown in FIGS. 2A and 2B, the sparging structure 60 is located within the tank 20 and is in fluid communication with a source of a conditioning agent (see 770 in FIG. 7).

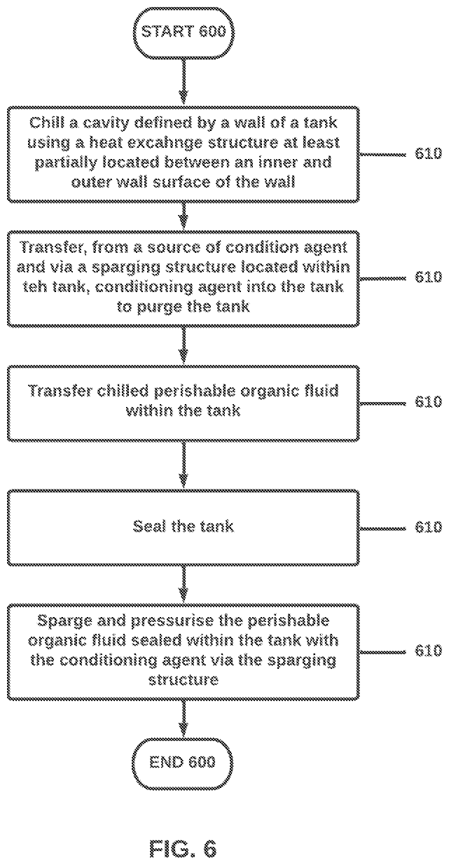

The use of the storage assembly 10 will now be described with reference to a method depicted by FIG. 6. In particular, at step 610, the method 600 includes chilling the cavity defined by the wall 90 of the tank 20 using the heat exchange structure 40 at least partially located between an inner and outer wall surface 92, 94 of the wall 90. At step 620, the method 600 includes transferring, from a source of conditioning agent and via the sparging structure 60 located within the tank 20, a first portion of conditioning agent 100 into the tank 20 to purge the tank 20. At step 630, the method 600 includes transferring chilled perishable organic fluid 110 within the tank 20. At step 640, the method 600 includes sealing the tank 20. At step 650, the method 600 includes pressurising and sparging the perishable organic fluid 110 sealed within the tank 20 with a second portion of the conditioning agent 110 via the sparging structure 60. At this point, the storage assembly 10 containing the perishable organic fluid 110 is suitable for transportations for substantial periods of time (e.g., greater than 21 days).

Whilst steps 610 and 620 of method 600 are depicted as being performed in sequential order, which is possible, it is noted that steps 610 and 620 can be performed in reverse order or simultaneously, at least in part or in full.

Advantageously, the stored perishable organic fluid 110 does not spoil for a considerable period of time (e.g., >21 days) despite the lack of pasteurisation or treatment to the perishable organic fluid 110. Due to this substantial timeframe which the perishable organic fluid 110 can be stored within the tank of the storage assembly 10 without spoilage, transportation of high quality raw perishable organic fluid 110 can be achieved over substantial distances (e.g., between countries or continents) which was not able to be previously achieved without pasteurisation or treatment which was less desired by customers.

The disclosed storage assembly 10 and method 600 has been found to be extremely effective for raw milk (i.e., unpasteurised milk). However, other perishable organic fluids 110 have been found to also be suitable for use with the disclosed storage assembly 10 and method 600. For example, perishable organic fluids 110 such as dairy products, vegetable juices, fruit juices, plant extracts, fungal extracts, flavouring agents, and combinations thereof may be stored using the disclosed storage assembly 10 and method 600.

In a preferable form, the perishable organic liquid 110 is chilled to a temperature above the freezing temperature of the respective perishable organic liquid. In particular, for raw milk which has a freezing temperature of −0.5° C., the raw milk can be chilled to between 0° C. to 4° C. and more preferably between 0° C. to 0.5° C. at the point of being received within the tank 20. In specific examples relating to raw milk, the raw milk is stored in a storage tank 710 associated with a farm or the like and cooled to the described temperature range within 36 hours after milking. Various cooling arrangements and methodologies can be utilised to chill the perishable organic liquid 110. The chilled perishable organic liquid can be received via the sealable port 26 of the tank 20 located at one of the ends of the tank 20 and toward the base thereof, wherein the sealable port 26 of the tank 20 could be used as both an inlet to receive the chilled perishable organic liquid 110 as well as an outlet for emptying the tank 20 of the perishable organic liquid 110 after transportation.

As shown in FIG. 5, the heat exchange structure 40 located between the inner and outer surfaces 92, 94 of the wall 90 can be provided in the form of a heat exchange conduit structure, such as one or more pipes 42 extending along a cavity 98 within the wall 90. The pipes 42 may form one or more coils that wraps around the tank 20. The heat exchange structure 40 may be a recirculating heat exchange structure wherein heat exchange fluid is pumped and recirculated through the heat exchange conduit structure. The heat exchange conduit structure can be coupled to and in fluid communication with a heat exchange fluid source (760 of FIG. 7), wherein the heat exchange fluid that is pumped and recirculated through the heat exchange structure 40 returns to the heat exchange fluid source 760. As shown in FIGS. 1 and 3, a first hose 44 can be coupled to an inlet of the heat exchange structure 40 and a second hose 46 can be coupled to an outlet of the heat exchange structure 40. The heat exchange fluid can be recirculated after being cooled by a cooling device. In one example, the heat exchange fluid can be a food grade heat exchange fluid such as glycol or water, although it will be appreciated that other liquids could be used. In preferable configurations. the cavity of the tank 20 is chilled to a temperature between 0° C. to 0.5° C. prior to receiving the perishable organic fluid 110.

In addition to the heat exchange structure 40 being located between the inner and outer surface 92, 94 of the wall 90, an insulating material 96 can also be provided between the inner and outer surface 92, 94 of the wall 90. The insulating material 96 may be provided in the form of a glass-based insulating material. More specifically, the insulating material can be located adjacent to the inner surface 92 of the wall 90 and the pipes 42 of the heat exchange structure 40. The insulating material assists with maintaining the chilled temperature of the tank prior to receiving the perishable organic fluid as well as maintaining the temperature of the perishable organic fluid below a threshold temperature during transportation for significant time periods (e.g., −21 days). The pressurisation and sparging of the perishable organic fluid, as well as the volume/mass of the perishable organic fluid, also assists with help maintain the temperature of the perishable organic fluid below a threshold temperature during transportation for significant time periods (e.g., −21 days).

Referring to FIGS. 2A and 2B, there is shown a cross-sectional side and plan view of the tank 20 of the storage assembly 10 which clearly show the sparging structure 60. As can be seen in FIGS. 2A and 2B, the sparging structure 60 includes a lattice structure of conduits substantially evenly distributed about the base of the cavity of the tank 20. In particular, the lattice structure of the sparging structure 60 includes a combination of interconnected members having a plurality of holes to allow conditioning agent to flow therethrough. The sparging structure 60 is secured within the tank 20 of the storage assembly 10, such as via welding. The sparging structure 60 is in fluid communication with the source of the conditioning agent via a further one or more conduits 102 which in a preferable form extend along the end side and upper surface of the tank 20, as shown in FIGS. 1 and 3, and therewithin to connect with the sparging structure 60. The conditioning agent 100 provided to the sparging structure 60 for both purging, sparging and pressurising the tank 20 is preferably carbon dioxide. As such, when gas (e.g., air) contained within the tank 20 is purged as discussed above, the tank 20 is filled with primarily carbon dioxide. In one particular form, the conditioning agent 100 may be pumped to the sparging structure 60.

Once the tank 20 is sealed containing the perishable organic liquid 110, the sparging structure 60 is configured to sparge the perishable organic fluid 110 with the conditioning agent 100 at a concentration of between 0.06 grams per litre to 1.2 grams per litre, and more preferably at a concentration of about 0.06 grams per litre. It will be appreciated that a regulator may be connected in series with the sparging structure 60 to regulate the flow of the condition agent 100 to the tank 20. In preferable arrangements, the sparging structure 60 is configured to pressurise the perishable organic fluid 110 to a pressure of between 1 kPa to 400 kPa above atmospheric pressure, and preferably between 90 kPa and 110 kPa above atmospheric pressure, and more preferably at about 100 kPa above atmospheric pressure. The pressurisation of the perishable organic fluid is preferably maintained during transportation of the storage assembly 10. As previously discussed, the condition agent is preferably carbon dioxide which inhibits the growth of unwanted microorganisms within the perishable organic fluid.

As seen in FIGS. 1 to 4, the tank 20 has a substantially cylindrical or capsule-like profile. In specific arrangements, the tank 20 can be 24,000 litre ISO container which is secured within a rectangular frame support structure 30 to enable stacking of the storage assembly 10 for transportation. The frame support structure 30 can be made of a metal material such as steel. Due to the frame support structure 30, the storage assembly 10 can be stacked upon each other or stacked on or under shipping containers. It will be appreciated that in particular examples the rectangular frame support structure 30 can have dimensions that correspond to dimensions (i.e., width, height, length) of a 24,000 litre ISO container.

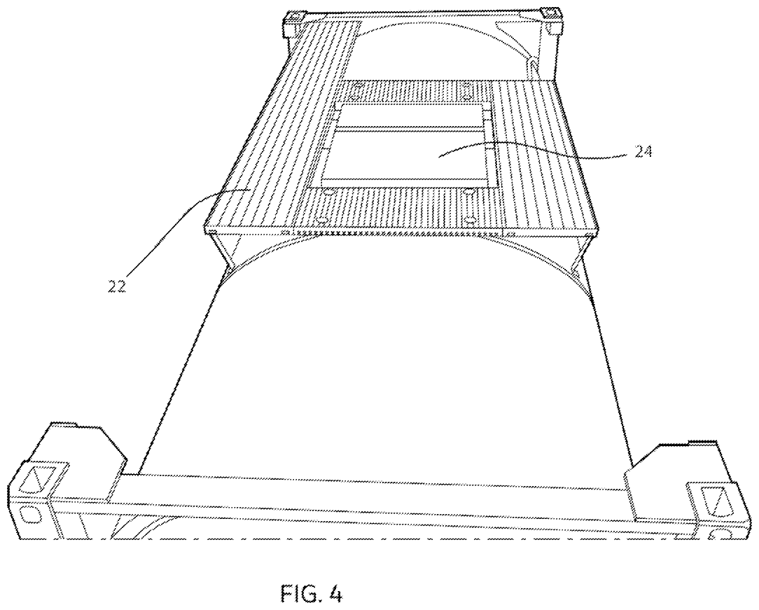

As shown in FIG. 4, the tank 20 can have a manhole assembly 24 located on the top portion of the tank 20. This manhole assembly 24 can be covered with an outer layer lid in addition to the manhole lid. In examples, the tank 20 can also include a pressure relief valve (not shown) to assist with releasing any excess pressure that develops with the tank 20 during purging and/or other steps of the transfer and storage process. In addition to various components of the tank 20 discussed above, the tank 20 can also include an air inlet preferably connected to a valve to control flow of air. On the top surface of the tank 20, a support surface 22 (i.e., walkway) is attached thereto to support an operator standing on the storage assembly 10 during operation, etc. The storage assembly 10 further includes a ladder 50 (see FIG. 3) secured to the frame and/or tank at the same end side of the tank 20 as the inlet/outlet port 26 to allow an operator to climb up to the mesh support surface 22.

Referring to FIG. 7 there is shown a block diagram representing a system 700 including a stationary storage assembly 710, a heat exchange system 730 and a mobile storage assembly 720. The stationary storage assembly 710 comprises a tank 712, a sparging structure 714 located within the tank 712. The tank 712 has a cavity defined by a wall, wherein the wall includes a sealable port for receiving and storing a perishable organic fluid within the tank. The sparging structure 714 is located within the tank 712 and is in fluid communication with a source of a conditioning agent 750. The sparging structure 714 is configured in the same manner as described with reference to FIGS. 1 to 5 and is adapted to transfer some of the conditioning agent into the tank 712 to purge the entire tank 712 (or the headspace if partially full) prior to receiving perishable organic fluid and then pressurise and sparge the perishable organic fluid with the conditioning agent after transfer and sealing within the tank 712. The heat exchange system 730 is configured to cool and maintain a storage temperature of the perishable organic fluid within the tank 712. The tank 712 and sparging structure 714 of the mobile storage assembly 720 can be configured in the same manner as described in relation to storage assembly 10 described with reference to FIGS. 1 to 5.

In this system 700, the stationary storage assembly 710 is generally located on a site where the perishable organic fluid is sourced. For example, in the instance the perishable organic fluid is raw milk, the stationary storage assembly 710 may be located and installed on a dairy farm or milking facility. Generally, the stationary storage assembly 710 has the same or similar capacity to the mobile storage assembly 720 (e.g., 24,000 litres). Advantageously, a farm or milking facility which is unable to fill the tank 712 to maximum capacity with perishable organic fluid can incrementally fill the tank 712 over a plurality of separate filling sessions (e.g., over different time periods such as separate days) until the tank 712 is full. After each transfer of perishable organic fluid within the tank 712 of the stationary storage assembly 710, the headspace is purged with the sparging structure 714 located within the tank 712 of the stationary storage assembly 710 prior to sparging and pressurisation.

The heat exchange system 730 can cool and maintain a storage temperature of the perishable organic fluid within the tank 712 of the stationary storage assembly 710. The heat exchange system 730 may be at least partially integrated with the stationary storage assembly 710. For example, the stationary storage assembly 710 may be configured in the same manner as storage assembly 10 including a heat exchange structure 40 located within the tank wall 90. The heat exchange structure can be coupled to a compressor which circulates a heat exchange medium through the heat exchange structure to cool and/or maintain a storage temperature of the perishable organic fluid within the tank 712 of the stationary storage assembly 710 However, it will be appreciated that it is possible to use other types of heat exchange systems to cool and maintain the storage temperature of the perishable organic fluid within the tank 712 of the stationary storage assembly 710.

Once the tank 712 of the stationary storage assembly 710 has reached maximum capacity, the mobile storage assembly 720 is conveyed, such as via a vehicle 1000 like a truck, to the site and located adjacent to the stationary storage assembly 710. The mobile storage assembly 720 is configured according to the storage assembly 10 as described with reference to FIGS. 1 to 5. The stationary and mobile storage assemblies 710, 720 can be placed in fluid communication with each other via conduits extending between respective ports (e.g., hoses, pipes, or the like) to allow the transfer of the perishable organic fluid stored within the tank 712 of the stationary storage assembly 710 to the tank of the mobile storage assembly 720. It will be appreciated that the port shown in FIG. 7 for stationary storage assembly 710 has been shown located at the opposing end of the tank 710 for the purposes of clarity. In one form, a pumping mechanism 740 may be located between the stationary and mobile storage systems 710, 720 to facilitate the fluid transfer. The method 600 described above in relation to FIG. 6 can be applied to the mobile storage assembly 720 for receiving and storing the perishable organic fluid.

As shown in FIG. 7, the vehicle 1000 may have located thereon a portable source of conditioning agent 770 and a portion of a heat exchange system 760 configured to chill the tank 722 and maintain the cooled temperature of the perishable organic fluid as described in relation to FIG. 6.

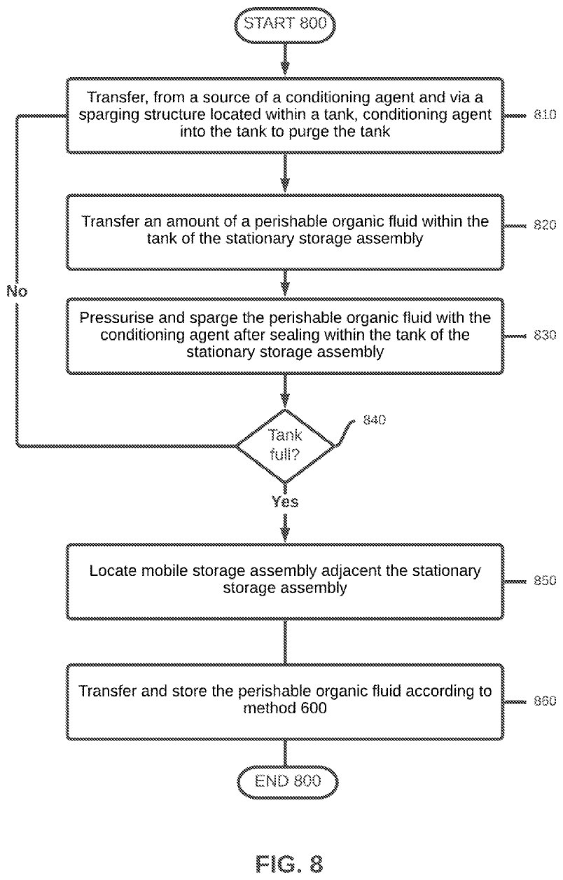

Referring to FIG. 8, there is shown a flowchart representing a method 800 of operating the system 700 described with reference to FIG. 7.

At step 810, the method 800 includes transferring, from a first source of a conditioning agent and via a sparging structure 714 located within the tank 712, conditioning agent into the tank 712 to purge the tank 712 of the stationary storage assembly 710. As will be appreciated from the below description, in some instances the tank will be partially full of perishable organic fluid, thus only the headspace is purged. However, in the event the tank 710 is empty, the tank 710 is fully purged.

At step 820, the method 800 includes transferring an amount of a perishable organic fluid within a tank 712, wherein the amount of perishable organic fluid is less than the maximum capacity of the tank 712, wherein the tank 712 of the stationary storage assembly 710 has a cavity defined by a wall including a sealable port for receiving and storing the perishable organic fluid within the tank 712 of the stationary storage assembly 710.

At step 830, the method 800 includes pressurising and sparging the perishable organic fluid with the conditioning agent after sealing within the tank 712 of the stationary storage assembly 710.

At step 840, the method 800 includes determining if the tank 712 is full. Steps 810 to 830 are repeated until the tank 712 has reached maximum capacity. Once maximum capacity has been reached, the method 800 moves to step 850.

At step 850, the method 800 includes locating a mobile storage assembly 720 adjacent the stationary storage assembly 710.

At step 860, the method 800 includes transferring the perishable organic fluid contained within the tank 712 of the stationary storage assembly 710 to the tank 722 of the mobile storage assembly 720. As mentioned above, the mobile storage assembly 710 is configured according to the storage assembly 10 described with referenced to FIGS. 1 to 5 including a sparge structure 724. Furthermore, the transfer and storage of the perishable organic fluid can be performed in accordance with method 600 described with reference to FIG. 6.

In preferable forms of the method 800, the stationary storage assembly 710 can be operated in a similar manner to the method 600. In particular, prior to receiving any perishable organic fluid within the tank 722 (i.e., the tank 712 is empty), the method 800 can include chilling the cavity of the tank 722 defined by the wall using the heat exchange system 760. In one form, the heat exchange system 760 includes the heat exchange structure which is at least partially located between an inner and outer wall surface of the wall of the tank 722. Furthermore, the tank 722 may be maintained at a cooled storage temperature using the heat exchange system 760.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Furthermore, when an element is referred to as being “electrically coupled” to another element, it denotes that a path of low resistance is present between such elements, while when an element is referred to as being simply “coupled” to another element, there may or may not be a path of low resistance between such elements.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

Throughout this specification and claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A storage assembly for storing a perishable organic liquid, comprising:
a tank having a cavity defined by a wall, wherein the wall includes a sealable port for receiving and storing a perishable organic fluid within the tank, wherein the perishable organic fluid is chilled prior to transfer to the tank;
a heat exchange structure at least partially located between an inner and outer wall surface of the wall, wherein prior to receiving the perishable organic fluid the heat exchange structure is configured to chill the cavity; and
a sparging structure located within the tank, wherein the sparging structure is in fluid communication with a source of a conditioning agent, wherein the sparging structure is configured to:
transfer a first portion of the conditioning agent into the tank to purge the tank prior to receiving the perishable organic fluid; and
sparge and pressurise the perishable organic fluid with a second portion of the conditioning agent after transfer and sealing within the tank.

2. The storage assembly according to claim 1, wherein perishable organic fluid is raw milk.

3. The storage assembly according to claim 1, wherein the heat exchange structure is a heat exchange conduit structure in fluid communication with a heat exchange fluid source, wherein an insulating material is located between the inner and outer surface of the wall to assist with maintaining a temperature of the perishable organic fluid within the tank after pressurising and sparging.

4. The storage assembly according to claim 1, wherein the conditioning agent is carbon dioxide.

5. The storage assembly according to claim 1, wherein the sparging structure is in fluid communication with the source of the conditioning agent via a further conduit which is at least partially located between the inner and outer surface of the wall of the tank.

6. The storage assembly according to claim 5, wherein the cavity of the tank is chilled to a temperature between 0° C. to 0.5° C. prior to receiving the perishable organic fluid.

7. The storage assembly according to claim 1, wherein the sparging structure is configured to sparge the perishable organic fluid with the conditioning agent at a concentration of between 0.06 grams per litre to 1.2 grams per litre.

8. The storage assembly according to claim 1, wherein the sparging structure includes a lattice structure of open conduits extending within the cavity of the tank.

9. The storage assembly according to claim 1, wherein the sparging structure is configured to pressurise the perishable organic fluid to a pressure of between 1 kPa to 400 kPa above atmospheric pressure.

10. A method for storing a perishable organic liquid, comprising:
chilling a cavity defined by a wall of a tank using a heat exchange structure at least partially located between an inner and outer wall surface of the wall;
transferring, from a source of conditioning agent and via a sparging structure located within the tank, conditioning agent into the tank to purge the tank;
transferring chilled perishable organic fluid within the tank;
sealing the tank; and
sparging and pressurising the perishable organic fluid sealed within the tank with the conditioning agent via the sparging structure.

11. The method according to claim 10, wherein perishable organic fluid is raw milk.

12. The method according to claim 10, wherein the method includes pumping a heat exchange liquid through the heat exchange structure in a recirculating manner.

13. The method according to claim 12, wherein the heat exchange structure is a heat exchange conduit structure in fluid communication with a heat exchange fluid source, wherein an insulating material is located between the inner and outer surface of the wall to assist with maintaining a temperature of the perishable organic fluid within the tank after pressurising and sparging.

14. The method according to claim 10, wherein the conditioning agent is carbon dioxide.

15. The method according to claim 10, wherein the method includes chilling the cavity to a temperature between 0° C. to 0.5° C. prior to receiving the perishable organic fluid.

16. The method according to claim 10, wherein the method includes sparging the perishable organic fluid with the conditioning agent at a concentration of between 0.06 grams per litre to 1.2 grams per litre.

17. The method according to claim 10, wherein the method includes pressurising the perishable organic fluid to a pressure of between 1 kPa to 400 kPa above atmospheric pressure.

18. A system including:
a stationary storage assembly comprising
a tank having a cavity defined by a wall, wherein the wall includes a sealable port for receiving and storing a perishable organic fluid within the tank;
a sparging structure located within the tank, wherein the sparging structure is in fluid communication with a source of a conditioning agent, wherein the sparging structure is configured to:
transfer some of the conditioning agent into the tank to purge the tank prior to receiving the perishable organic fluid; and
sparge and pressurise the perishable organic fluid with the conditioning agent after transfer and sealing within the tank; and
a heat exchange system configured to cool and maintain a storage temperature of the perishable organic fluid within the tank; and
a mobile storage assembly configured in accordance with claim 1, wherein the second storage assembly is locatable substantially adjacent to and in fluid communication with the first storage assembly such that the perishable organic fluid stored within the first storage assembly is transferrable to and storage within the tank of the mobile storage assembly.

19. The system according to claim 18, wherein the perishable organic fluid is raw milk and the stationary storage assembly is located at a farm or milking facility.

20. The system according to claim 18, wherein the heat exchange system includes a heat exchange structure at least partially located between an inner and outer wall surface of the wall of the tank of the mobile storage assembly, wherein prior to receiving any perishable organic fluid, the heat exchange structure is configured to chill the cavity, and wherein the insulating material is configured to assist with maintaining a temperature of the perishable organic fluid within the tank after pressurising and sparging.
